(19) United States
(12) Patent Application Publication
(10) Pub. No.: US 2012/0049500 A1
(43) Pub. Date: Mar. 1, 2012

(54) Dual Stage Pretensioning and High Pay-In Capacity Pretensioning Retractor

(76) Inventors: Bin Wang, Windsor (CA); Frank Kiiskila, Leonard, MI (US); Daniel K. Webb, Oxford, MI (US); Jon E. Burrow, Ortonville, MI (US); Kurt W. Schulz, Romeo, MI (US); Chad E. Moore, Rochester Hills, MI (US); Gerald J. Keller, Shelby Township, MI (US)

(21) Appl. No.: 12/872,285

(22) Filed: Aug. 31, 2010

(51) Int. Cl. B60R 22/46

(52) U.S. Cl. 280/806

(57) ABSTRACT

A seat belt retractor for use in seat belt restraint systems. The retractor incorporates dual rotopretensioner units and adaptive load limiting characteristics. Preferably, the rotopretensioners are positioned on opposite ends of a retractor spool for driving the spool for pretensioning rotation. A first pretensioner may be activated alone to provide pretensioning rotation. In one embodiment of the invention, if the second pretensioner is not activated, the system will be engaged to provide a given belt load limiting characteristic. A second rotopretensioner may be fired either after the first pretensioner is fired to increase pay-in capacity or to activate a different load limiting characteristic for the retractor.

### FIELD OF THE INVENTION

This invention relates to a seat belt retractor of a type used as part of a seat belt occupant restraint system, particularly adapted for motor vehicle applications.

### BACKGROUND OF THE INVENTION

Seat belt retractors are in common use in motor vehicles around the world as part of an occupant restraint system for providing occupant protection. Seat belt retractors store belt webbing which is deployed across an occupant in the typical so-called “active” type belt system, in which the occupant manually fastens the belt. The seat belt retractor typically incorporates a torsion rewind spring which enables an internal spindle to store a spool of seat belt webbing. The retractor allows extension of the belt during fastening and retraction when it is unfastened. The basic functions of the retractor are to provide convenient storage of belt webbing, enable occupant movement when the belt is fastened, and control the extension of belt webbing upon the occurrence of a crash event.

Significant advances have been made in recent decades in the area of motor vehicle occupant restraints. In addition to passive restraints, such as inflatable air cushion restraint systems, the area of belt restraint systems has also undergone significant advancement. Two areas of advancements in retractor design are particularly noteworthy. Retractor pretensioning devices are often provided which are typically pyrotechnically actuated and forcibly wind up the belt retractor to reduce slack in the webbing upon the detection of a crash event (or prior to). By reducing the slack in the webbing by pretensioning, the belt is able to couple with the occupant early in the crash sequence to provide control of the occupant's displacement relative to the vehicle. Taking up webbing slack and tightening the belt at the initial portion of the crash sequence also enables belt loading to be managed better while restraining the occupant. Pretensioning also helps provide proper positioning of the belt webbing on the occupant's body during a crash event.

Another area of significant development in seat belt retractors is providing seat belt webbing load limiting. Early retractors had spindles which were rigidly locked, typically by an inertia sensitive device which locked the spool to the retractor frame. Upon retractor locking, loads exerted on the belt webbing would result in some stretching of the webbing and deflection of the retractor and other belt system components. However, the extension of the webbing in retractors without load limiting features was not tailored in a precise manner. Accordingly, these retractors could result in high loads applied to the occupant which can lead to less than optimal restraint performance. To improve performance, designers have developed load limiting systems for retractors. Load limiting systems typically use a torsion bar coupled between the webbing spindle and the inertial locking device which provides controlled torsional deflection in response to belt webbing loads. Twisting of the torsion bar will “soften” the restraint characteristics of the belt retractor. In yet a further refinement of belt load limiting systems, multilevel load limiting systems have been implemented. These systems may have one, two, or more sections of torsion bar or other deformable elements which can be activated in a controlled manner, depending on a number of factors. For example, it may be desirable to provide a high belt load limiting characteristic when a high severity crash is occurring, or where a large and heavy occupant is involved. On the other hand, for lower severity impacts, or for lighter weight occupants, less stiff load limiting characteristics are desired. Retractors are presently known which have a pyrotechnic device which can be fired through a controller to select between high and low load limiting conditions, depending on a variety of factors, such as those mentioned previously.

Providing retractors with increasing features has disadvantages, including the cost to provide these features, the complexity of the retractor, and the packaging size in the vehicle required for installation and operation of the retractor. Motor vehicle designers are constantly striving to reduce the mass, cost, and enhance the packaging efficiency of their products, including seat belt retractors.

In a continuous effort to enhance performance, seat belt safety system designers are seeking to increase the amount of belt pay-in capacity during pretensioning operation. Current retractor rotopretensioners provide excellent performance, but have a limitation in the amount of webbing pay-in capability. Moreover, there is a desire to increase the flexibility of the operation of a retractor during pretensioning to accommodate various types of impact scenarios and also perform well for occupants of various structures. Present retractors with pretensioning systems are generally capable of operating in a single impact condition. Although the pretensioning effect is provided following an initial impact, additional pretensioning may be desired to enhance occupant protection during a secondary impact. This is the case since slack is introduced in the system after an initial impact.

### SUMMARY OF THE INVENTION

In accordance with this invention, a seat belt retractor having a dual stage pretensioning and high pay-in capacity is provided which achieves many enhancements in view of the previously noted desirable characteristics. The seat belt retractor in accordance with an embodiment of this invention includes a pair of separate rotopretensioners which are activated by firing micropyrotechnic gas generators. Preferably the rotopretensioners are positioned at opposite ends of the retractor spool and can be coupled to the spool in various manners. The high pay-in capacity of a dual rotopretensioner system will enable significant amounts of slack to be removed in a system in an impact condition by firing the rotopretensioners in a serial manner. This can be achieved without exceeding desired limits on pretensioning force. In addition, if a single rotopretensioner is fired following an initial impact, the second rotopretensioner can be activated upon the occurrence of a secondary impact or to provide more webbing pay-in in a single impact event. Another capability provided by the dual stage pretensioning retractor in accordance with this invention is the ability to establish load limiting functions based on the activation of the pretensioner. Thus, when one pretensioner is fired, a certain load limiting characteristic can be provided, whereas if only the second pretensioner is fired, a different load limiting characteristic can be provided. This enables optimization for various impact severities, and occupant types.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a perspective view of a dual stage pretensioning retractor in accordance with a first embodiment of this invention;

FIG. 2 is a front elevational view of the retractor in accordance with this invention;

FIG. 3 is a side elevational view of the retractor in accordance with the present invention;

FIG. 4 is a cross-sectional view of the retractor taken along line 4-4 in FIG. 3;

FIG. 5 is an exploded pictorial view of the spindle assembly of the retractor in accordance with this invention;

FIG. 6 is a cross-sectional view through the retractor taken along line 6-6 of FIG. 2 showing the spindle assembly and pretensioner components;

FIG. 7 is a view similar to FIG. 4 while showing the operation of the device in a first stage pretensioning mode;

FIG. 8 is a cross-sectional view similar to FIG. 4 showing the retractor in a second stage pretensioning mode;

FIG. 9 is a cross-sectional view taken along line 9-9 from FIG. 2;

FIG. 10 is a cross-sectional view similar to FIG. 6 showing the retractor in a low level load limiting mode.

FIG. 11 is a cross-sectional view similar to FIG. 4 showing the retractor in a high load level limiting mode; and

FIG. 12 is a curve showing progressive load limiting provided by firing both pretensioners.

### DETAILED DESCRIPTION OF THE INVENTION

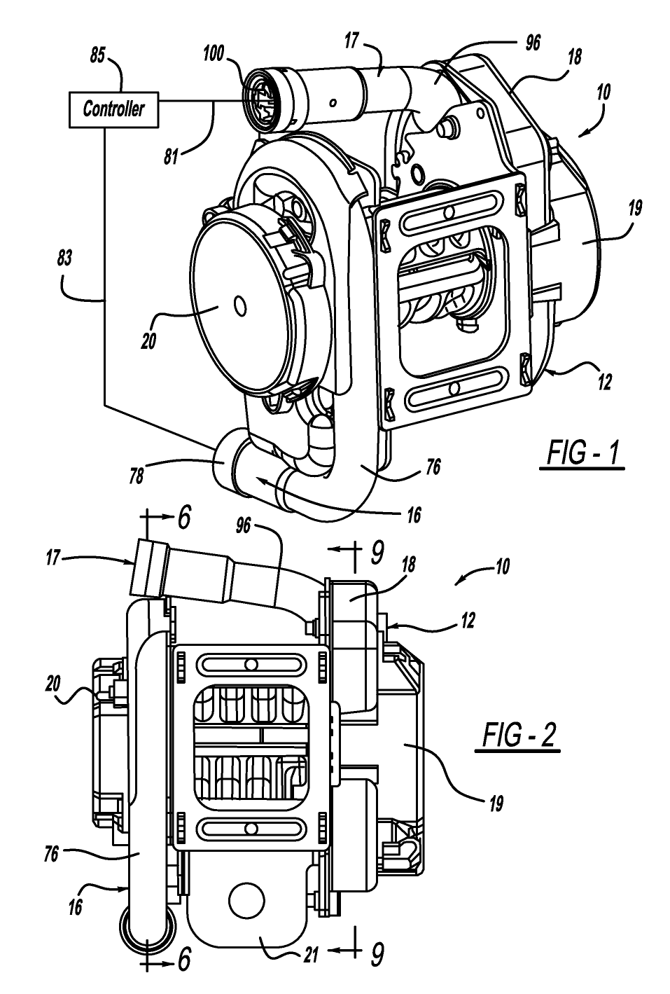

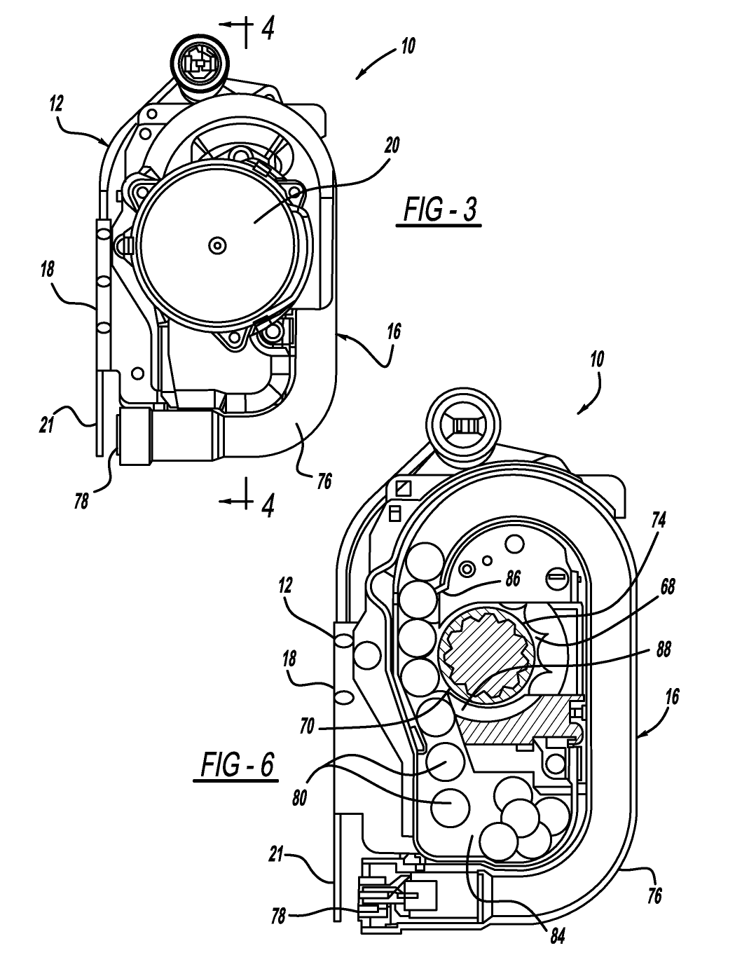

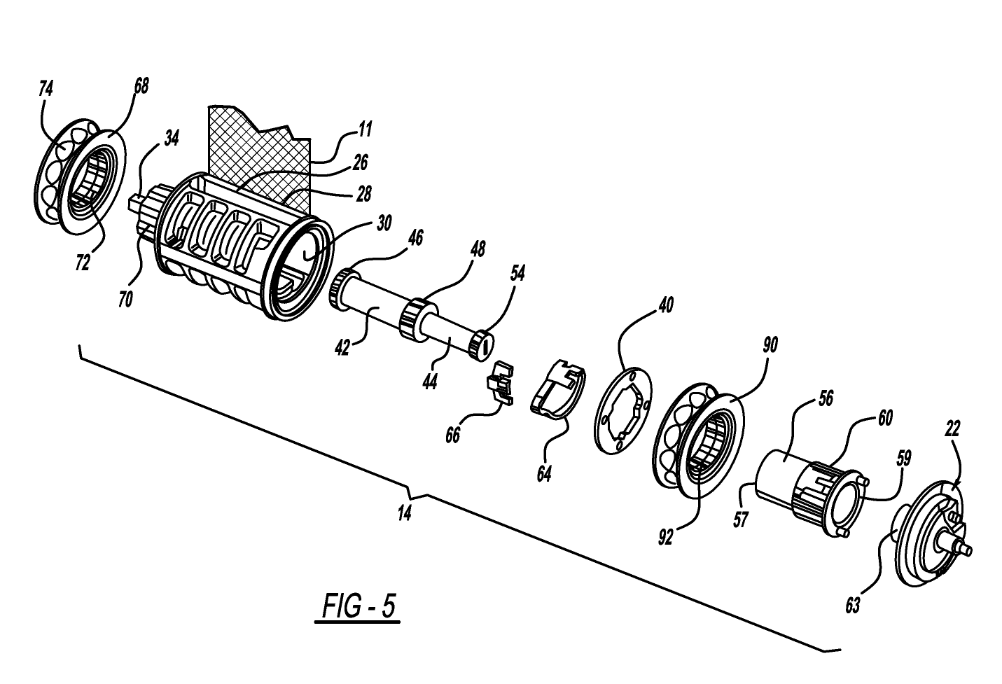

FIGS. 1, 2, and 3 illustrate seat belt retractor 10 in accordance with the present invention. Retractor 10 may be employed in a conventional three-point active belt system, and can be used for single or dual retractor configurations. Seat belt retractor 10 has, as major subsystems, frame assembly 12, spindle assembly 14, first pretensioner assembly 16, and second pretensioner assembly 17. Seat belt retractor 10 is used for allowing seat belt webbing 11 (shown in FIG. 5) to be stowed on the spindle assembly 14, for pretensioning, and for controlling the forces applied on the seat belt webbing during restraint operation, as will be described in greater detail in the following discussion.

Frame assembly 12 includes frame 18 which is formed from sheet metal stock and bent in a generally “U” shape and a pretensioner cover 19 that is connected to frame 18 by fasteners. Frame 18 includes means for mounting the retractor to a motor vehicle structure, principally through tab 21 with a bore for a threaded fastener or other fastening means (not shown). Frame 18 forms mounting surfaces for remaining components of retractor 10. Torsion spring cap 20 is affixed to one end of frame 18 and includes an internal torsion spring (not shown) which exerts a torsional compliant force onto spindle assembly 14 for rewinding the belt webbing 11. Mechanism cover 19 is attached to frame 18 and is typically molded of a plastic material. Tread head assembly 22 is mounted to the opposite “leg” of frame 18. Tread head assembly 22 has internal inertia sensitive components (not shown) of conventional design which cause locking of retractor 10 in response to vehicle deceleration above a predetermined magnitude. This operation of tread head assembly 22 is in accordance with well known prior art principles, and is not described in detail here. Tread head assembly 22 operates to provide an emergency locking retractor (ELR) function. This allows webbing 11 to be freely paid out from retractor 10, allowing movement of the occupant and extension of the seat belt webbing except when deceleration forces above a predetermined magnitude are acting on the retractor. The inertia sensors of the seat belt retractor 10 will cause tread head assembly 22 to lock, either in response to acceleration forces exceeding a given magnitude and direction acting on the retractor, as well as in conditions where the motor vehicle is in an inclined condition. In these cases, tread head assembly 22 locks spindle assembly 14 to frame 18. Frame assembly 12 further includes a number of additional elements illustrated such as protective caps and other elements not directly related to the features of the present invention.

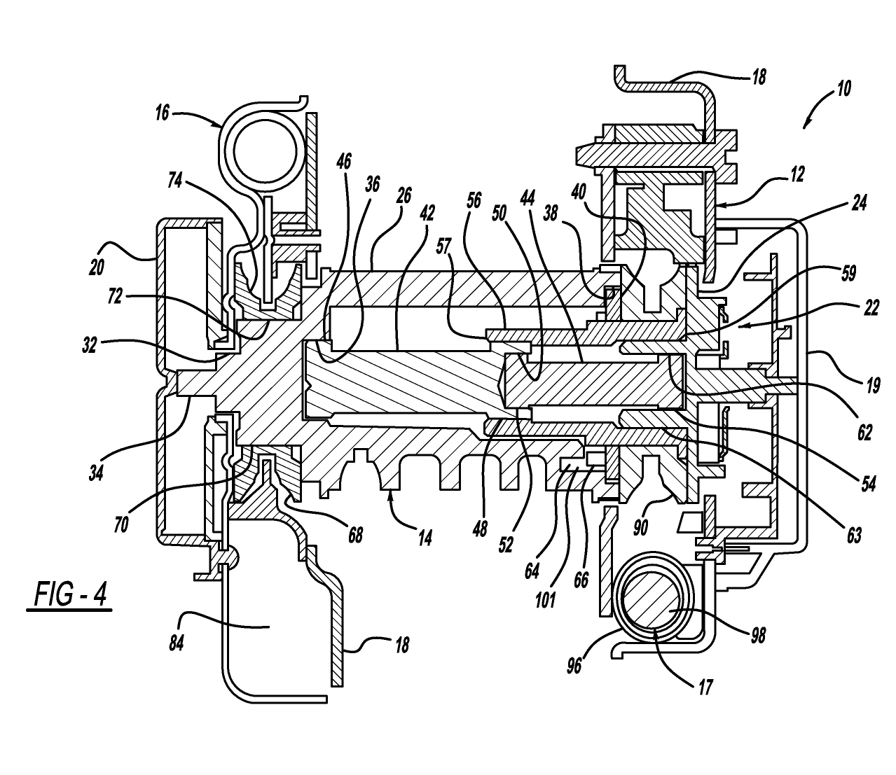

Now with specific reference to FIGS. 4 and 5, the elements of spindle assembly 14 are illustrated. Spindle 26 (also known as a spool) provides an outer cylindrical surface 28 upon which seat belt webbing is wrapped. Spindle 26 further forms a hollow interior cavity 30 within which other components are installed. Spindle 26 is mounted into bearing journal 32 which allows the spindle to rotate relative to frame element 18. Spindle 26 further has a protruding post 34 along its longitudinal axis which extends into spring cap 20 and provides a means for a torsion rewind spring (not shown) to engage with the spindle. Spindle hollow interior cavity 30 forms a reduced diameter splined bore 36 at its end adjacent spring cap 20. Spindle 26 is open on its right hand end, as the parts are illustrated in FIGS. 4 and 5. The open end forms a stepped internal bore including a bearing bore surface 38 which receives bearing disc 40. Bearing disc 40 allows for free rotation of spool 26 during load limiting webbing extension.

Installed coaxially within hollow interior cavity 30 of spindle 26, is a pair of elongated torsion bars, including high level torsion bar 42, and a low level torsion bar 44. Bar 42 has an enlarged head 46 which is splined to engage with spindled spindle bore 36. The opposite end of torsion bar 42 forms an outer perimeter rim 48 which has external splines as well as a splined end bore 50 which receives and meshes with a splined headed end 52 of low level torsion bar 44. Torsion bar 44 further forms splined end 54. End 54 is splined into an internal splined bore 62 of tread head hub 24. Torque transfer tube 56 has an open end 57 with internal splines which engage and mesh with torsion bar rim 48 and an opposite end 59 having external splines 60.

Torque transfer tube end 59 is mounted over hub tube projection 63. This connection is preferably not splined and allows some relative rotation between tread head hub 24 and torque tube 56 during load limiting webbing extension. A degressive bending element 64 is interlocked through bearing disc 40 to torque tube 56 and is coupled to spindle 26 by degressive insert 66.

In some operating circumstances, some relative rotation between torque tube 56 and tread head hub 24 is desirable. However, it may be further desirable to limit such angular rotation until a torque level of given magnitude is exerted between these two components. For example, shear pins (not shown) could be installed between tread head hub 24 and torque tube 56 which would shear when a predetermined torque is applied between them.

As mentioned previously, retractor 10 features a pair of pretensioner assemblies, including first pretensioner assembly 16 and second pretensioner assembly 17. First pretensioner assembly 16 is shown at the left hand side of retractor 10 as illustrated in FIGS. 2 and 4, and shown in section in FIG. 6. First pretensioner unit 16 is located between retractor frame 18 and torsion spring cap 20. First pretensioner assembly 16 includes pinion 68 which is fixed for rotation onto spindle 26 through interaction of splined post 70 and internal splines 72 formed by the pinion. The outside surface of pinion 68 features ball grooves 74 which interact with pretensioner balls 80, as will be described in further detail. As best shown in FIG. 6, pretensioner tube 76 has a microgas generator 78 mounted at one end. Microgas generator 78 responds to a firing signal on line 83 applied by controller 85 to pyrotechnically generate gas directed into tube 76. A series of pretensioner balls 80 are loaded into pretensioner tube 76. The first ball 80 or other element closely fits with the inside diameter of pretensioner tube 76 and acts as a piston to drive the other balls.

Pretensioner tube 76 guides balls 80 to follow a generally circular path when they are driven to move through the pretensioner tube such that they engage with pinion ball grooves 74 for forcibly rotating spindle 26 in a known manner. A cavity 84 is positioned to act as a ball trap, in which balls 80, after traveling the path formed by pretensioner tube 76, are held. Ball separators 86 and 88 are provided to guide balls 80 so that they engage with pinion 68 in a desired, tangent manner, in accordance with conventional rotopretensioner design principles. Upon firing of microgas generator 78, the ball chain formed by balls 80 is driven forcibly through tube 76 until they interact with pinion 68 which causes the pinion and accordingly spindle 26 to rotate in a direction to pretension the associated seat belt webbing. Other types of engagement elements could replace balls 80 such as chain type elements which would drive the pinion when the unit is activated.

Presently designed rotopretensioner units often have provisions for locking rotation of the spindle after actuation, which locking action can be used to engage operation of load limiting elements or to otherwise act as a lock to restrict extraction of webbing from the retractor. In the present invention in which a pair of pretensioning units 16 and 17 are employed, it is desirable that at least one of the pretensioning units does not have a locking function, in other words, acting in an “off clutch” manner (not locked). In the described embodiment, pretensioner 16 does not lock, whereas pretensioner 17 locks after actuation (the reverse characteristic could be provided if desired). This feature means that the rotation of spindle 26 will not be controlled by pretensioning unit 16 after it is activated (gas generator 78 is fired). A further discussion of the operation of pretensioning unit 16 will be provided in the following sections.

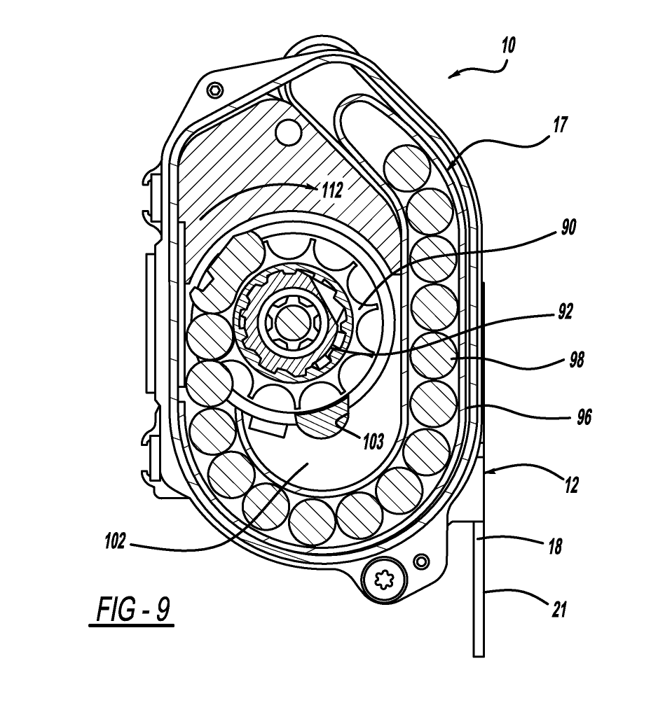

Second pretensioning unit 17 is best shown with reference to FIGS. 4 and 9. Pinion 90 has internal splines 92 which lock it for rotation onto corresponding provided splines 60 on the outside of torque transfer tube at end 59. Pretensioner 17 includes pretensioner tube 96, which like pretensioner 16 and conventional rotopretensioners, includes a series of balls 98 and is activated by microgas generator 100. A firing signal on line 81 from controller 85 fires generator 100. Second rotopretensioner 17 operates in a manner similar to pretensioner 16 except that it is desirable that, after actuation, pretensioner 17 locks spindle 26. After actuation, a group of balls 98 fall within ball trap 102. Pretensioner tube 96 can be pressure sealed to maintain pressure in the tube to prevent back-driving of balls 98, or a mechanical stop can be provided to “jam” balls 98 after activation to prevent back-driving. For example, notch 103 can be provided in which a ball 98 fits into upon back-driving movement of pinion 90, thus jamming the pinion. This approach is further described by U.S. patent application Ser. No. 12/246,920 which is commonly owned with this invention and is hereby incorporated by reference.

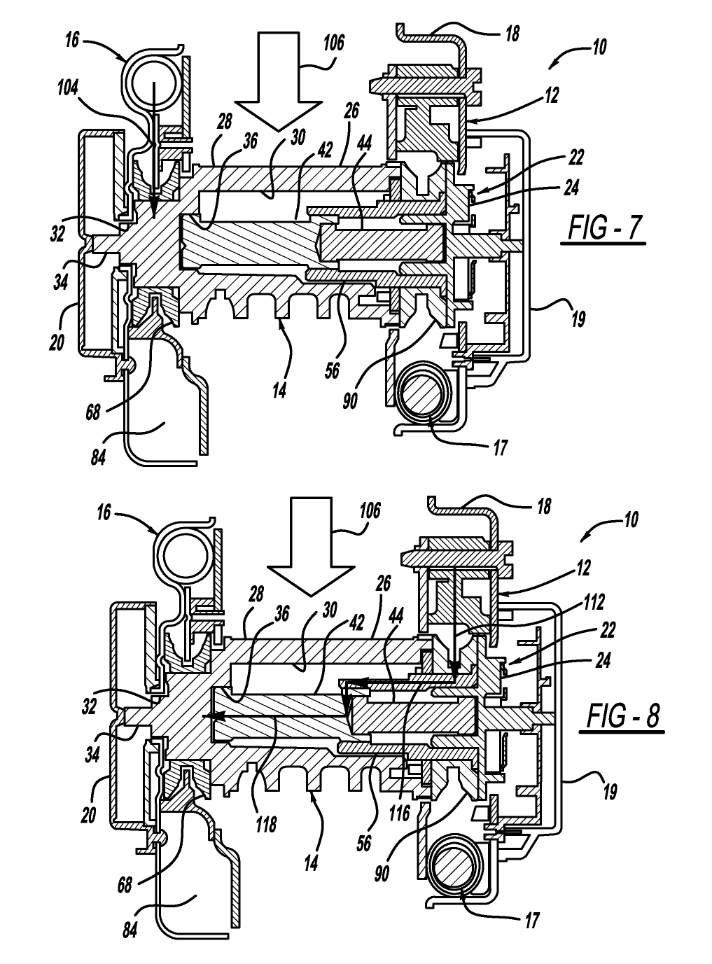

Various operational modes for retractor 10 are provided employing the features of the present invention. With reference to FIG. 7, a first stage pretensioning operation is depicted. This operational scenario might occur upon the occurrence of an impact. In this first stage of pretensioning, microgas generator 78 is fired, driving balls 80 of first pretensioner 16 to engage with pinion 68, driving it to rotate as indicated by arrow 104. This action causes rotation of spindle 26 and pretensioning of the belt webbing, as designated by arrow 106. As mentioned previously, first pretensioner 16 does not lock spindle 26 after actuation.

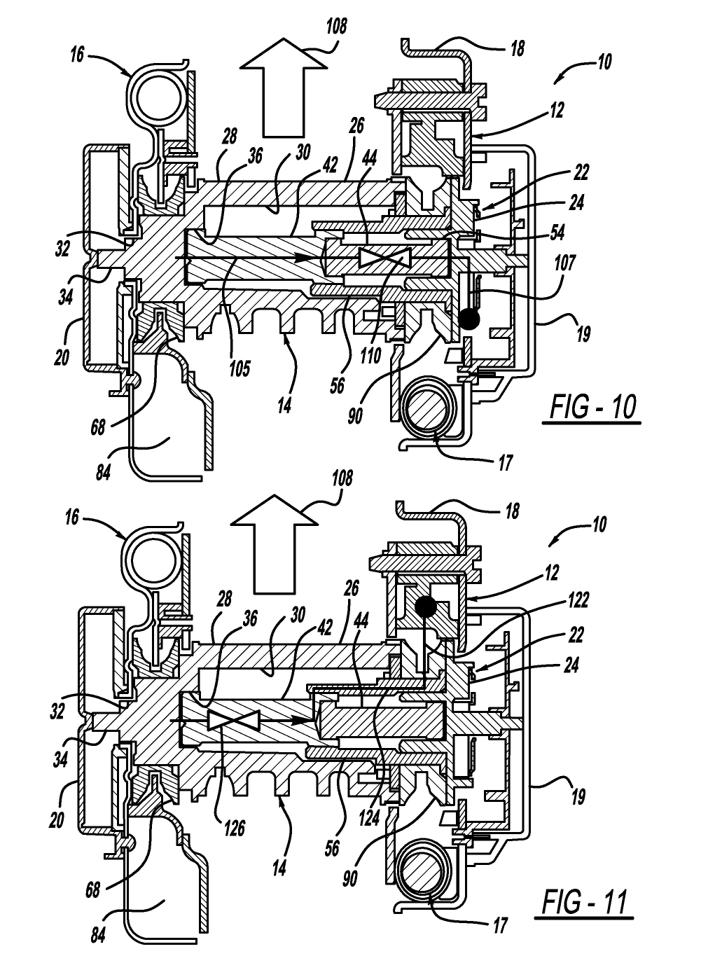

If second pretensioner 17 is not fired, a locking of retractor 10 occurs through the action of tread head assembly 22 resulting from inertial forces acting on the retractor. The loading conditions acting through retractor 10 are illustrated in FIG. 10. As a belt webbing restraint force is exerted as indicated by arrow 108, tread head assembly 22 causes low level torsion bar end 54 to be grounded to frame 18 through the tread head assembly. Thus, restraint forces exerted as indicated by arrow 108 are restrained through torque applied both to torsion bars 42 and 44, and act along lines 105 and 107. Torque tube 56 is free to rotate and does not restrict torsion of bar 44. However, given the lower torsional stiffness of low level torsion bar 44 (as compared to bar 42), that bar undergoes significant torsional deflection (which may include plastic deformation) as indicated by the double headed arrow 110 in FIG. 10. If no other operating actions are taken, the restraint event will continue until restraint loads are relieved.

FIG. 8 illustrates the operating condition referred to as a second stage of pretensioning (not necessarily occurring after activation of first pretensioner 16). This second stage of pretensioning occurs through firing of second pretensioner assembly 17 through a firing signal sent on line 81 activating microgas generator 100. As previously described, this operation drives balls 98 to rotate spindle 26 as shown by FIG. 9. This action is designated by arrow 112. Rotation of pinion 90 causes rotation of spindle 26 through rotation of torque tube 56 as designated by arrow 116 and to the spindle through torsion bar 42 as indicated by arrow 118. These movements cause pretensioning retraction as indicated by arrow 106. When second pretensioner 17 is operated, first pretensioner pinion 68 is rotated counter-clockwise in FIG. 6, which drives pretensioner balls 80 into the ball trap 84. In the event that first pretensioner 16 is fired and the system is operating in a load limiting phase, reverse rotation of pinion 68 occurs (during extension of belt webbing 11) in which pretensioner balls 80 may be driven back into pretensioner tube 76 as the pinion rotates in the clockwise direction.

Now with reference to FIG. 11, an operational mode in which retractor 10 provides high load level limiting is illustrated. After activation, second pretensioner 17 locks pinion 90 to the retractor frame, as indicated by line 122. Restraint forces acting on the seat belt webbing indicated by arrow 108 are transferred to frame 18 through high load level torsion bar 42 and through torque tube 56, which as mentioned previously, occurs with forces acting along lines 122 and 124. A double headed arrow 126 shown in FIG. 11 indicates that torsional deflection is occurring through torsion bar 42 (which may include plastic deformation), which provides a high load limiting characteristic. Even where tread head 72 is locking, thus grounding end 54 of low level torsion bar 44, due to the relative torsional stiffness of the two torsion elements, high level torsion bar 42 primarily controls belt loads in this operating condition.

Bending element 64 is fixed to torque tube 56 through bearing disc 40 and degressive insert 66 fits in a pocket 101 in the spindle 26. In the event of activation of high level load limiting, a degressive decrease in belt loading may be provided. Initially, element 64 and insert 66 act with high level torsion bar 42 to control belt webbing loads, since they both couple spindle 26 to pinion 90. If, in a high load limiting mode, deflection of the spool (or loads) exceeds a predetermined level, bending element 64 will be pulled through from bending of insert 66, whereupon the loads are transferred only by high level torsion bar 42, to provide a degressive operation to a lower load limiting (lower than when both elements are acting).

A number of different operating conditions are possible using retractor 10. The action of controller 85 selects these operation conditions. The range of possibilities include at least the following:
Single pretensioner firing for low load level limiting. This mode corresponds with activating only pretensioner 16 by controller 85 which provides the low load limiting functions mentioned previously. This mode is illustrated by FIGS. 7 and 10.
Single pretensioner firing with high load level limiting characteristics. This operation is mentioned previously in which only pretensioner 17 is activated, providing a high load level characteristic with a possibility of degressive decrease in load limiting. This mode is illustrated by FIGS. 8 and 11.
Simultaneous activation of dual pretensioners. In this mode, both pretensioner assemblies 16 and 17 are fired near or at the same time. This provides high pretensioning force since both act together. This operation may be desired in certain impact types.
Serial activation of dual pretensioners. In this mode of operation, controller 85 first activates first pretensioner 16, since after its activation, first pretensioner 16 does not ground the spindle 26 to the retractor frame 18. After the initial operation where low load leveling characteristic is provided, it may be desirable in the same impact sequence or upon the occurrence of a secondary impact to activate second pretensioner 17. Due to the serial operation of the pretensioners 16 and 17, a large amount of pretensioning pay-in is provided which exceeds that available through activation of a single rotopretensioner. As mentioned previously, webbing slack introduced after initial impact can be taken up with activation of the second pretensioner or controller 85 may provide the serial firing after an initial delay is desirable in a given impact condition. Where it is desired to be able to active both first and second pretensioners 16 and 17, it is necessary to first fire pretensioner 16 since initial firing of pretensioner 17 would result in spindle 26 being locked in which case first pretensioner 16 would not be capable of driving the spindle for pretensioning motion. A simplified design of retractor 10 could eliminate the dual load limiting characteristics described previously. For such a retractor, pretensioners 16 and 17 would be utilized for their high pay-in capacity and multiple impact capabilities, not for selecting load limiting levels.

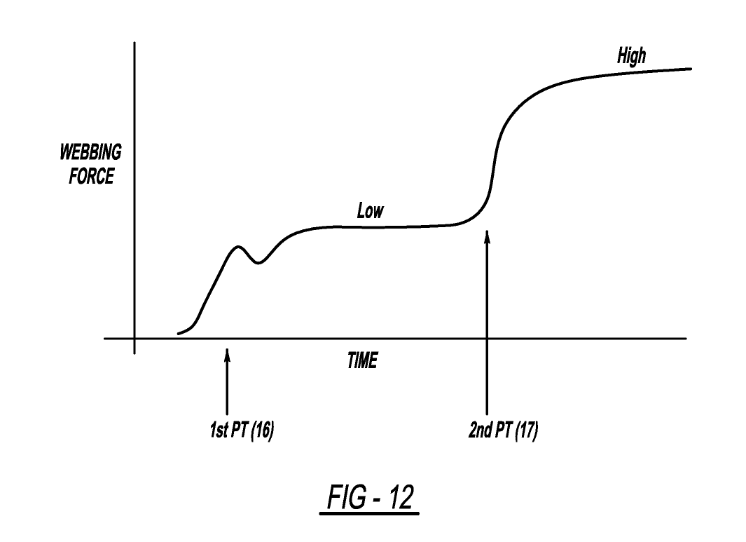

In the last mentioned sequence when second pretensioner 17 is fired during or after low load limiting, the load limiting level goes from low to high, as shown in FIG. 12. This progressive load limiting characteristic may be desired for multi-impact or rollover situations.

Retractor 10 provides, in addition to great flexibility for dealing with occupant and impact types, also the ability to adapt retractor 10 to varying automotive safety requirements, vehicle characteristics, and regulations in jurisdictions throughout the world. Moreover, automotive manufacturers often have their own performance specifications which a single retractor design may not be able to accommodate. Retractor 10 provides a high pretensioning pay-in capacity to remove excessive webbing slack without increasing pretensioning force beyond acceptable levels. The system further provides different power levels to adjust belt occupant coupling. As also described, the system can accommodate multiple impacts by serially activating pretensioners. Also, based on which of pretensioners 16 or 17 is activated, a high or low load level load limiting characteristic can be provided, depending on accident severity and occupant type.

While the above description constitutes the preferred embodiment of the present invention, it will be appreciated that the invention is susceptible to modification, variation, and change without departing from the proper scope and fair meaning of the accompanying claims.

1. A dual pretensioner seat belt retractor for seat belt webbing of a motor vehicle occupant restraint system, comprising:
a retractor frame adapted to be mounted to the motor vehicle,
a spindle assembly supported for rotation by the retractor frame and having a spindle adapted for winding the webbing, the spindle assembly further having a first and a second pretensioner pinion,
a first pretensioner assembly for causing the first pinion to rotate the spindle for pretensioning the belt webbing upon activation of the first pretensioner assembly,
a second pretensioner assembly for causing the second pinion to rotate the spindle for pretensioning the belt webbing, and
one of the first or the second pretensioner assembly having locking means for locking the respective first or the second pinion to the frame after the activation thereof, and the other of the first or the second pretensioner assembly allowing rotation of the respective first or the second pinion relative to the frame after the activation thereof.

2. A dual pretensioner seat belt retractor in accordance with claim 1 wherein at least one of the first or the second pretensioner assembly in the form of a rotopretensioner having a pretensioner tube with engagement elements therein and a gas generator, wherein upon activation of the gas generator, the engagement elements are driven to travel in the tube and engage the respective first or second pinion to drive the pinion to rotate.

3. A dual pretensioner seat belt retractor in accordance with claim 1 wherein both the first and the second pretensioner assembly in the form of rotopretensioners each having a respective first and second pretensioner tube, with first and second engagement elements therein, and first and second gas generators, wherein upon activation of either of the gas generators, the respective first or second engagement elements are driven to travel in the respective first or second pretensioner tube and engage the respective first or second pinion to drive the spindle to rotate.

4. A dual pretensioner seat belt retractor in accordance with claim 1 wherein the first and second pretensioner pinions are positioned at opposite ends of the spindle assembly.

5. A dual pretensioner seat belt retractor in accordance with claim 1 wherein the retractor further comprises a tread head assembly which locks the spindle to the frame in response to inertial forces acting on the retractor.

6. A dual pretensioner seat belt retractor in accordance with claim 5 wherein the first pretensioner assembly allows rotation of the first pinion relative to the frame after the activation thereof and the second pretensioner assembly having locking means for locking the second pinion to the frame after the activation thereof.

7. A dual pretensioner seat belt retractor in accordance with claim 6 wherein the retractor further having one or more torsion bars for providing control of the tension forces on the seat belt webbing and wherein the one or more torsion bars are active to control the tension forces after at least one of the tread head assembly locking the spindle or the second pretensioner locking the spindle.

8. A dual pretensioner seat belt retractor in accordance with claim 6 wherein the retractor further having a high load limiting torsion bar and a low load limiting torsion bar, the spindle locked to the frame through the high level torsion bar when the tread head assembly or the second pretensioner locks the spindle thereby providing a high level webbing load limit, and the spindle locked to the frame through the low level torsion bar when the other of the tread head assembly or the second pretensioner locks the spindle thereby providing a low level webbing load limit.

9. A dual pretensioner seat belt retractor in accordance with claim 8 further comprising a degressive element which couples the spindle to the second pretensioner assembly wherein the webbing loads are restrained by both the high level torsion bar and the degressive element until the spindle undergoes rotational displacement relative to the second pretensioner assembly exceeding a predetermined rotational displacement whereupon the webbing loads become restrained only by the high level torsion bar thereby providing a degressive decrease in load limiting.

10. A dual pretensioner seat belt retractor in accordance with claim 1 further comprising a controller for sending activation signals to the first and the second pretensioners.

11. A dual pretensioner seat belt retractor in accordance with claim 10 wherein the retractor further having a high load limiting torsion bar and a low load limiting torsion bar, the spindle locked to the frame through the high level torsion bar when the tread head assembly or the second pretensioner locks the spindle thereby providing a high level webbing load limit, and the spindle locked to the frame through the low level torsion bar when the other of the tread head assembly or the second pretensioner locks the spindle thereby providing a low level webbing load limit, the controller selectively activating the first or the second pretensioner to select between high and low level load limit conditions.

12. A dual pretensioner seat belt retractor in accordance with claim 11 wherein the controller activates the first and second pretensioner in a serial manner.

13. A dual pretensioner seat belt retractor in accordance with claim 12 wherein the controller activates the first and second pretensioner in a serial manner with the first pretensioner being activated first to provide the low load limiting limit and thereafter activating the second pretensioner to provide the high load limiting limit.

14. A dual pretensioner seat belt retractor for seat belt webbing of a motor vehicle occupant restraint system, comprising:
a retractor frame adapted to be mounted to the motor vehicle,
a spindle assembly supported for rotation by the retractor frame and having a spindle adapted for winding the webbing, the spindle assembly further having a first and a second pretensioner pinion,
a first rotopretensioner assembly for causing the first pinion to rotate the spindle for pretensioning the belt webbing upon activation of the first pretensioner assembly, the first rotopretensioner assembly having a first pretensioner tube, with first engagement elements therein, and a first gas generator, wherein upon activation of the first gas generator, the first engagement elements are driven to travel in the first pretensioner tube and engage the first pinion to drive the spindle to rotate,
a second pretensioner assembly for causing the second pinion to rotate the spindle for pretensioning the belt webbing upon activation of the second pretensioner assembly, the second rotopretensioner assembly having a second pretensioner tube, with second engagement elements therein, and a second gas generator, wherein upon activation of the second gas generator, the second engagement elements are driven to travel in the second pretensioner tube and engage the second pinion to drive the spindle to rotate, and
one of the first or the second pretensioner assembly having locking means for locking the respective first or the second pinion to the frame after the activation thereof, and the other of the first or the second pretensioner assembly allowing rotation of the respective first or the second pinion relative to the frame after the activation thereof.

15. A dual pretensioner seat belt retractor in accordance with claim 14 wherein the first and second pretensioner pinions are positioned at opposite ends of the spindle assembly.

16. A dual pretensioner seat belt retractor in accordance with claim 14 wherein the retractor further comprises a tread head assembly which locks the spindle to the frame in response to inertial forces acting on the retractor.

17. A dual pretensioner seat belt retractor in accordance with claim 16 wherein the first pretensioner assembly allows rotation of the first pinion relative to the frame after the activation thereof, and the second pretensioner assembly having locking means for locking the second pinion to the frame after the activation thereof.

18. A dual pretensioner seat belt retractor in accordance with claim 17 wherein the retractor further having one or more torsion bars for providing control of the tension forces on the seat belt webbing and wherein the one or more torsion bars are active to control the tension forces after at least one of the tread head assembly locking the spindle or the second pretensioner locking the spindle.

19. A dual pretensioner seat belt retractor in accordance with claim 18 wherein the retractor further having a high load limiting torsion bar and a low load limiting torsion bar, the spindle locked to the frame through the high level torsion bar when the tread head assembly or the second pretensioner locks the spindle thereby providing a high level webbing load limit, and the spindle locked to the frame through the low level torsion bar when the other of the tread head assembly or the second pretensioner locks the spindle thereby providing a low level webbing load limit.

20. A dual pretensioner seat belt retractor in accordance with claim 19 further comprising a degressive element which couples the spindle to the second pretensioner assembly wherein the webbing loads are restrained by both the high level torsion bar and the degressive element until the spindle undergoes rotational displacement relative to the second pretensioner assembly exceeding a predetermined rotational displacement whereupon the webbing loads become restrained only by the high level torsion bar thereby providing a degressive decrease in load limiting.

21. A dual pretensioner seat belt retractor in accordance with claim 14 further comprising a controller for sending activation signals to the first and the second pretensioners.

22. A dual pretensioner seat belt retractor in accordance with claim 21 wherein the retractor further having a high load limiting torsion bar and a low load limiting torsion bar, the spindle locked to the frame through the high level torsion bar when the tread head assembly or the second pretensioner locks the spindle thereby providing a high level webbing load limit, and the spindle locked to the frame through the low level torsion bar when the other of the tread head assembly or the second pretensioner locks the spindle thereby providing a low level webbing load limit, the controller selectively activating the first or the second pretensioner to select between high and low level load limit conditions.

23. A dual pretensioner seat belt retractor in accordance with claim 21 wherein the controller activates the first and second pretensioner in a serial manner.

24. A dual pretensioner seat belt retractor in accordance with claim 23 wherein the controller activates the first and second pretensioner in a serial manner with the first pretensioner being activated first to provide the low load limiting limit and thereafter activating the second pretensioner to provide the high load limiting limit.

25. A dual pretensioner seat belt retractor for seat belt webbing of a motor vehicle occupant restraint system, comprising:
a retractor frame adapted to be mounted to the motor vehicle,
a spindle assembly supported for rotation by the retractor frame and having a spindle with a hollow interior and an outer surface adapted for winding the webbing, a first torsion bar and a second torsion bar positioned end to end and at least partially disposed within the spindle hollow interior, the first torsion bar having an end fixed to the spindle, the second torsion bar having an end coupled to a spindle hub, the first and second torsion bars arranged end to end and meeting at a rim, the rim coupled with a second pretensioner pinion, and a first pretensioner pinion coupled to the spindle and a end thereof opposite the second pretensioner pinion,
a tread head assembly mounted to the retractor frame and engaging the spindle hub to lock the spindle to the frame in response to inertial loads acting on the retractor, and upon locking with the spindle, tension loads acting on the seat belt produce torque on the spindle carried through the first and second torsion bars, which provides a low seat belt load limiting function,
a first rotopretensioner assembly for causing the first pinion to rotate the spindle for pretensioning the belt webbing, and
a second rotopretensioner assembly for causing the second pinion to rotate the spindle for pretensioning the belt webbing and for locking the pinion to the frame with tension loads acting on the seat belt produce torque on the spindle are coupled through the first torsion bar section, thereby providing a high seat belt load limiting function, and wherein upon locking of the tread head assembly the seat belt produce torque on the spindle are coupled through the second torsion bar section, thereby providing a low load level limiting function.

26. A dual pretensioner seat belt retractor in accordance with claim 25 further comprising a degressive element which couples the spindle to the second pretensioner assembly wherein the webbing loads are restrained by both the high level torsion bar and the degressive element until the spindle undergoes rotational displacement relative to the second pretensioner assembly exceeding a predetermined rotational displacement whereupon the webbing loads become restrained only by the high level torsion bar thereby providing a degressive decrease in load limiting.

27. A dual pretensioner seat belt retractor according to claim 25 further comprising a torque transfer tube positioned around at least one of the torsion bars and connected with the torsion bar rim at one end thereof and with the second pretensioner pinion at another end thereof.

28. A dual pretensioner seat belt retractor according to claim 25 wherein the pretensioner spindle becomes locked to the retractor frame after activation of the second pretensioner assembly.

29. A dual pretensioner seat belt retractor in accordance with claim 25 wherein the first pretensioner assembly allows rotation of the first pinion relative to the frame after the activation thereof, and the second pretensioner assembly having locking means for locking the second pinion to the frame after the activation thereof.

30. A dual pretensioner seat belt retractor in accordance with claim 25 further comprising a controller for sending activation signals to the first and the second pretensioners.

31. A dual pretensioner seat belt retractor in accordance with claim 30 wherein the controller selectively activating the first or the second pretensioner to select between high and low level load limit conditions.

32. A dual pretensioner seat belt retractor in accordance with claim 30 wherein the controller activates the first and second pretensioner in a serial manner.

33. A dual pretensioner seat belt retractor in accordance with claim 32 wherein the controller activates the first and second pretensioner in a serial manner with the first pretensioner being activated first to provide the low load limiting limit and thereafter activating the second pretensioner to provide the high load limiting limit.
